(19) United States
(12) Patent Application Publication
(10) Pub. No.: US 2011/0219251 A1
(43) Pub. Date: Sep. 8, 2011

(54) INFORMATION PROCESSING APPARATUS AND CONTROL METHOD OF INFORMATION PROCESSING APPARATUS

(75) Inventor: Tetsuya Onishi, Kamakura-shi (JP)

(73) Assignee: CANON KABUSHIKI KAISHA, Tokyo (JP)

(21) Appl. No.: 13/125,564

(22) PCT Filed: Jan. 13, 2011
(86) PCT No.: PCT/JP2011/000122

§ 371 Date: Apr. 21, 2011

(30) Foreign Application Priority Data
Jan. 29, 2010 (JP) 2010-019437

(51) Int. Cl. G06F 1/32

(52) U.S. Cl. 713/323

(57) ABSTRACT

An information processing apparatus which operates in a normal mode or a power saving mode in which power consumption is lower as compared to the normal mode includes a volatile storage unit, a first supplying unit configured to supply power to the storage unit, a second supplying unit configured to supply, if the first supplying unit cannot supply power to the storage unit, power to the storage unit, a charging unit configured to charge, if the information processing apparatus is operating in the normal mode, the second supplying unit, a first measurement unit configured to measure an amount of time that the information processing apparatus operates in the normal mode after the information processing apparatus shifts to the normal mode; and

a control unit configured to control the information processing apparatus not to shift to the power saving mode until an amount of time measured by the first measurement unit becomes greater than a first predetermined amount of time.

### TECHNICAL FIELD

The present invention relates to an information processing apparatus and a control method of the information processing apparatus.

### BACKGROUND ART

There is an information processing apparatus that operates in a normal mode and in a power saving mode in which less power is consumed as compared to the normal mode. Japanese Patent Application Laid-Open No. 9-36996 discusses, when an information processing apparatus is not used for a predetermined time, the information processing apparatus is shifted from the normal mode to the power saving mode.

### Citation List

### Patent Literature

PTL 1: Japanese Patent Application Laid-Open No. 9-36996

### SUMMARY OF INVENTION

### Technical Problem

On the other hand, there is an information processing apparatus that includes a volatile storage medium. When power supply is stopped, the information processing apparatus backs up the volatile storage medium by supplying power from a battery.

The technique discussed in Japanese Patent Application Laid-Open No. 9-36996 may be applied to the above-described information processing apparatus. In such a case, if the information processing apparatus charges the battery only in the normal mode, the information processing apparatus may shift to the power saving mode even when the battery is not fully charged.

### Solution to Problem

The present invention is directed to preventing an information processing apparatus from shifting to a power saving mode when a battery for backing up a volatile storage unit is not fully charged.

According to an aspect of the present invention, an information processing apparatus which operates in a normal mode or a power saving mode in which power consumption is lower as compared to the normal mode includes a volatile storage unit, a first supplying unit configured to supply power to the storage unit, a second supplying unit configured to supply, if the first supplying unit cannot supply power to the storage unit, power to the storage unit, a charging unit configured to charge, if the information processing apparatus is operating in the normal mode, the second supplying unit, a first measurement unit configured to measure an amount of time that the information processing apparatus operates in the normal mode after the information processing apparatus shifts to the normal mode, and a control unit configured to control the information processing apparatus not to shift to the power saving mode until an amount of time measured by the first measurement unit becomes greater than a first predetermined amount of time.

Further features and aspects of the present invention will become apparent from the following detailed description of exemplary embodiments with reference to the attached drawings.

### BRIEF DESCRIPTION OF DRAWINGS

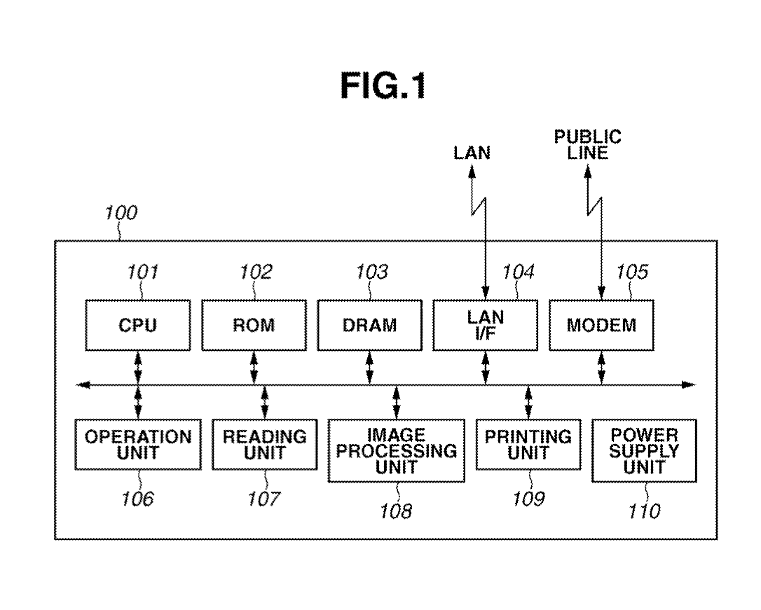

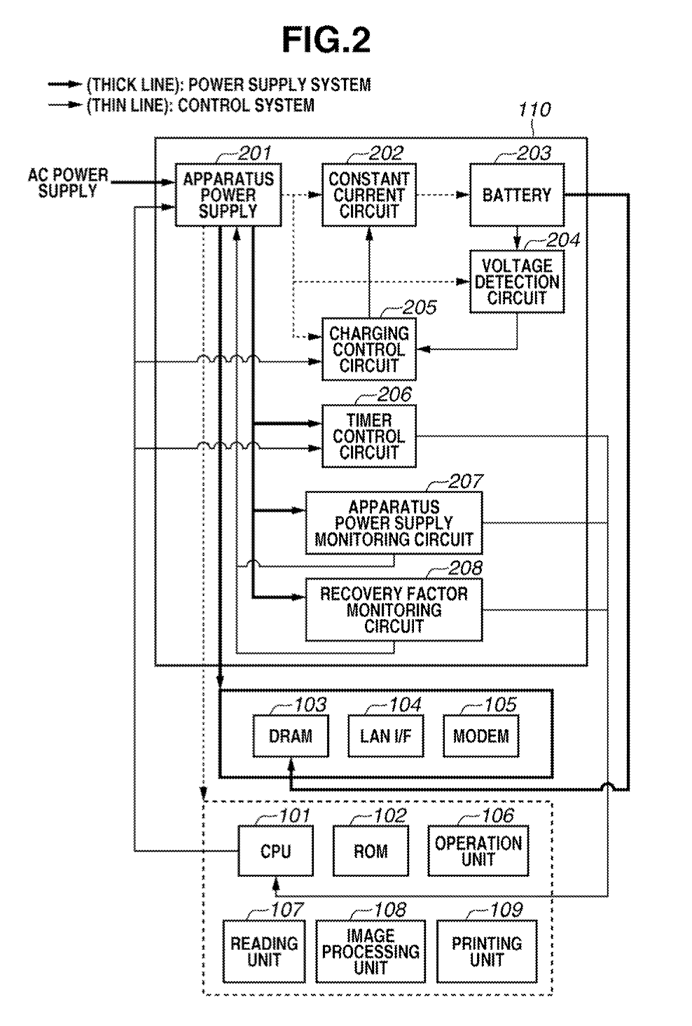

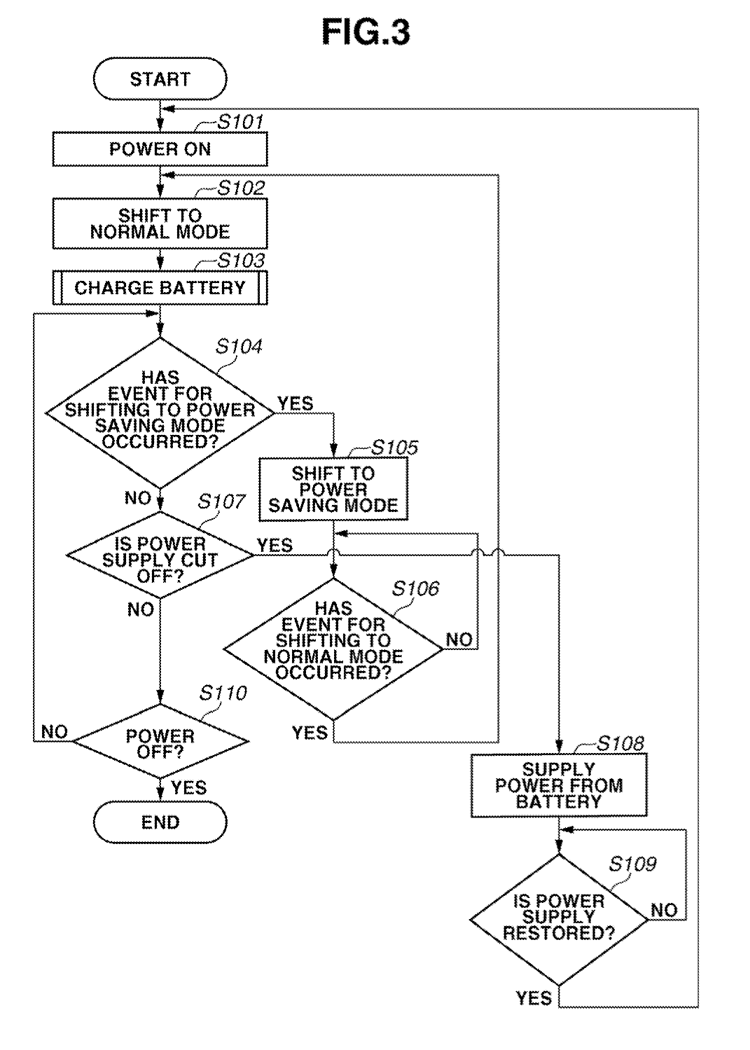

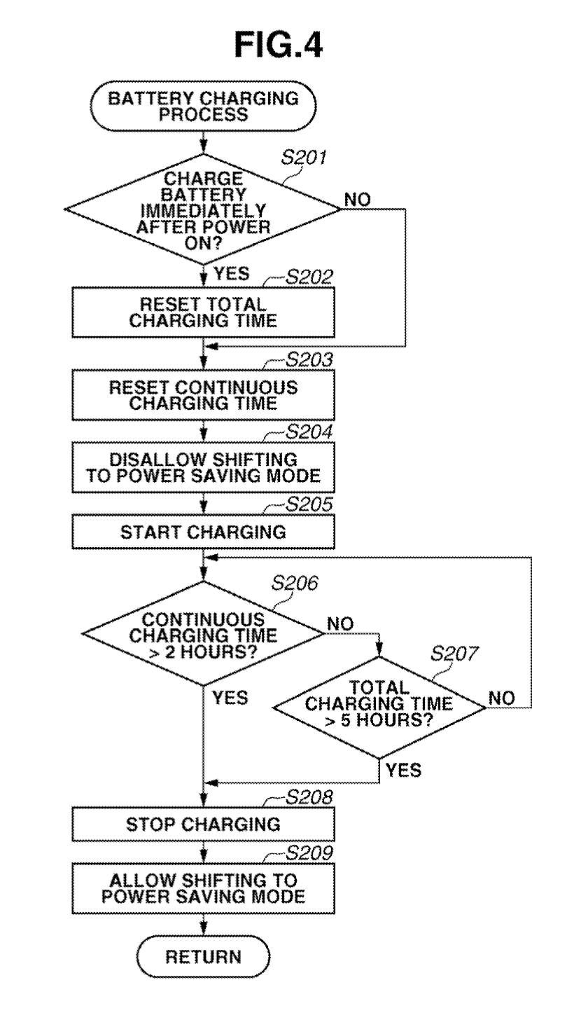

The accompanying drawings, which are incorporated in and constitute a part of the specification, illustrate exemplary embodiments, features, and aspects of the invention and, together with the description, serve to explain the principles of the invention.

[FIG. 1] FIG. 1 is a block diagram illustrating a configuration of a multifunction peripheral (MFP).

[FIG. 2] FIG. 2 is a block diagram illustrating details of a power supply unit.

[FIG. 3] FIG. 3 is a flowchart illustrating an operation of the MFP.

[FIG. 4] FIG. 4 is a flowchart illustrating details of charging a battery.

### DESCRIPTION OF EMBODIMENTS

Various exemplary embodiments, features, and aspects of the invention will be described in detail below with reference to the drawings.

According to the present invention, an MFP will be described as an example of an information processing apparatus. However, the information processing apparatus may be an apparatus other than the MFP.

FIG. 1 is a block diagram illustrating a configuration of an MFP 100. Referring to FIG. 1, a central processing unit (CPU) 101 controls the operations of the MFP 100. A read-only memory (ROM) 102 is a non-volatile storage medium that stores programs used by the CPU 101.

A dynamic random access memory (DRAM) 103 is a volatile storage medium that stores programs stored in the ROM 102 and image data input from a local area network (LAN) interface (I/F) 104, a modem 105, or a reading unit 107.

The LAN I/F 140 is used for inputting and outputting the image data to and from the MFP 100 and an external device via the LAN.

The modem 105 is used for inputting and outputting the image data to and from the MFP 100 and the external device via a public line. An operation unit 106 receives an instruction to operate the MFP 100 from a user. The reading unit 107 reads a document and inputs the image data. An image processing unit 108 performs various image processing on the image data input from the LAN I/F 104, the modem 105, and the reading unit 107.

A printing unit 109 prints an image on a sheet based on the image data on which the image processing unit 108 has performed image processing.

A power supply unit 110 is connected to an alternative current (AC) power supply and supplies power to each of the components in the MFP 100. The details of the power supply unit 110 will be described in detail below with reference to FIG. 2.

FIG. 2 is a block diagram illustrating in detail the power supply unit 110. Referring to FIG. 2, arrows drawn with a thick line indicate a flow of a power supply system, and arrows drawn with a thin line indicate a flow of a control system.

An apparatus power supply 201 (i.e., an example of a first supply unit) is connected to the AC power supply and supplies power to each component in the MFP 100.

A constant current circuit 202 sets a current received from the apparatus power supply 201 to a predetermined value and charges a battery 203.

The battery 203 (i.e., an example of a second supplying unit) supplies power to the DRAM 103 when the apparatus power supply 201 does not directly supply power to the DRAM 103 due to cutoff of the AC power supply.

A voltage detection unit 204 detects a voltage of the battery 203, transmits a signal to a charging control circuit 205, and prevents the battery 203 from becoming overcharged. The charging control circuit 205 operates on the constant current circuit 202 and controls charging of the battery 203.

A timer control circuit 206 (i.e., an example of a first measurement unit and a second measurement unit) measures various charging time periods (e.g., continuous charging time and total charging time) to be described below. An apparatus power supply monitoring circuit 207 detects a power supplying status of the apparatus power supply 201 and monitors whether the AC power supply is cut off. A recovery factor monitoring circuit 208 detects a factor for causing the MFP to recover from a power saving mode (i.e., shift to a normal mode).

FIG. 2 illustrates a status of power supply from the power supplying unit 110 to each component in the MFP 100. The MFP 100 operates in either of the two modes described below according to the status of power supply to each component.

A first mode is the normal mode. The normal mode is a mode in which the MFP is operating in a normal power state. In the normal mode, the apparatus power supply 201 supplies power to the components indicated by both the arrows drawn with the thick solid line and the broken line in FIG. 2.

A second mode is the power saving mode. The power saving mode is a mode in which the MFP operates in a power saving state in which power consumption is lower as compared to the normal mode. In the power saving mode, the apparatus power supply 201 supplies power only to the components indicated by the arrows drawn with the thick solid line in FIG. 2.

According to the present exemplary embodiment, there is only one power saving mode. However, there may be a plurality of power saving modes in which power is supplied to different components.

Further, if the AC power supply is cut off, the apparatus power supply 201 becomes unable to supply power to the components indicated by both the arrows drawn with the thick solid line and the broken line in FIG. 2. The battery 203 thus supplies power to the DRAM 103.

FIG. 3 is a flowchart illustrating the operation of the MFP 100. The operation illustrated in the flowchart is realized by the CPU 101 reading out the program stored in the ROM 102 to the DRAM 103 and executing it.

In step S101, the CPU 101 receives an instruction to turn on the MFP 100 from the user via the operation unit 106.

In step S102, the CPU 101 controls the apparatus power supply 201 to shift the MFP 100 to the normal mode.

In step S103, the CPU 101 controls the charging control circuit 205 to charge the battery 203. The process for charging the battery performed in step S103 will be described in detail below with reference to the flowchart illustrated in FIG. 4.

In step S104, the CPU 101 determines whether an event that is a predetermined factor (condition) for shifting the MFP 100 to the power saving mode has occurred. The predetermined factor is, for example, whether a predetermined time period has elapsed while the operation unit 106, the reading unit 107, the image processing unit 108, and the printing unit 109 have not operated. If the CPU 101 determines that the predetermined factor for shifting the MFP 100 to the power saving mode has occurred (YES in step S104), the process proceeds to step S105. On the other hand, if the CPU 101 determines that the predetermined factor for shifting the MFP 100 to the power saving mode has not occurred (NO in step S104), the process proceeds to step S107.

In step S105, the CPU 101 controls the apparatus power supply 201 to shift the MFP 100 to the power saving mode.

In step S106, the recovery factor monitoring circuit 208 determines whether an event that is a predetermined factor (condition) for shifting the MFP 100 to the normal mode has occurred. The predetermined factor is, for example, whether the LAN I/F 104 or the modem 105 has operated and received data. If the recovery factor monitoring circuit 208 determines that the predetermined factor for shifting the MFP 100 to the normal mode has occurred (YES in step S106), the process returns to step S102. If the recovery factor monitoring circuit 208 determines that the predetermined factor for shifting the MFP 100 to the normal mode has not occurred (NO in step S106), the recovery factor monitoring circuit 208 repeats the process in step S106 and waits until it is determined that the event has occurred.

In step S107, the CPU 101 receives a signal from the apparatus power supply monitoring circuit 207 and determines whether the AC power supply has been cut off. The CPU 101 and the apparatus power supply monitoring circuit 207 are connected by a capacitor (not illustrated) and thus may be operable for a certain amount of time even after the AC power supply is cut off. If the CPU 101 determines that the AC power supply has been cut off (YES in step S107), the process proceeds to step S108. If the CPU 101 determines that the AC power supply has not been cut off (NO in step S107), the process proceeds to step S110.

In step S108, the CPU 101 performs control so that the battery 203 supplies power to the DRAM 103.

In step S109, the apparatus power supply monitoring circuit 207 determines whether the AC power supply is restored. If the apparatus power supply monitoring circuit 207 determines that the AC power supply is restored (YES in step S109), the process returns to step S101. On the other hand, if the apparatus power supply monitoring circuit 207 determines that the AC power supply is not restored (NO in step S109), the apparatus power supply monitoring circuit 207 repeats the process in step S109 and waits until it is determined that the AC power supply is restored.

In step S110, the CPU 101 determines whether an instruction to turn off the MFP 100 has been received from the user via the operation unit 106. If the CPU 101 determines that the instruction to turn off the MFP 100 has been received from the user (YES in step S110), the CPU 101 ends the control. If the CPU 101 determines that the instruction to turn off the MFP 100 has not been received from the user (NO in step S110), the process returns to step S104.

FIG. 4 is a flowchart illustrating details of the battery charging process performed in step S103 illustrated in FIG. 3. In step S201, the CPU 101 inquires the recovery factor monitoring circuit 208 and determines whether charging of the battery in step S103 is to be performed immediately after the MFP 100 has been turned on. The CPU 101 makes the determination based on whether the recovery factor monitoring circuit 208 sends notification of that charging of the battery is performed immediately after the MFP 100 has been turned on. If the CPU 101 determines that charging of the battery is performed immediately after the MFP 100 has been turned on (YES in step S201), the process proceeds to step S202. On the other hand, if the CPU 101 determines that charging of the battery is performed not immediately after the MFP 100 has been turned on (NO in step S201), the process proceeds to step S203.

In step S202, the CPU 101 controls the timer control circuit 206 to reset a total charging time of the battery 203 to zero and newly start measuring the time. The total charging time is a total amount of time the MFP 100 has operated in the normal mode after the MFP 100 has been turned on, within an amount of time the battery is charged.

In step S203, the CPU 101 controls the timer control circuit 206 to reset a continuous charging time of the battery 203 to zero and newly start measuring the time. The continuous charging time is a total amount of time the MFP 100 has continuously operated in the normal mode after the MFP 100 has shifted to the normal mode, within the amount of time the battery 203 is charged.

In step S204, the CPU 101 controls the apparatus power supply 201 to disallow the MFP 100 to shift to the power saving mode. By performing the processes in step S204 and step S209, the MFP 100 is thus controlled not to shift to the power saving mode while performing the processes in step S205 to step S208.

In step S205, the CPU 101 controls the charging control circuit 205 to start charging the battery 203.

In step S206, the CPU 101 inquires the timer control circuit 206 to determine whether the continuous charging time has become longer than two hours (i.e., an example of a first predetermined time). If the CPU 101 determines that the continuous charging time has become longer than two hours (YES in step S206), the process proceeds to step S208. If the CPU 101 determines that the continuous charging time has not become longer than two hours (NO in step S206), the process proceeds to step S207.

In step S207, the CPU 101 inquires the timer control circuit 206 to determine whether the total charging time has become longer than five hours (i.e., an example of a second predetermined time which is longer than the first predetermined time). If the CPU 101 determines that the total charging time has become longer than five hours (YES in step S207), the process proceeds to step S208. If the CPU 101 determines that the total charging time has not become longer than five hours (NO in step S207), the process returns to step S206.

In step S208, the CPU 101 controls the charging control circuit 205 to stop charging the battery 203. The process in step S208 may be performed after the voltage detection circuit 204 detects that the battery 203 has become charged. Further, it is not necessary to completely stop charging the battery 203 in step S208, and a small amount of charging that can maintain the battery 203 may be continued by performing trickle charge.

In step S209, the CPU 101 controls the apparatus power supply 201 to allow the MFP 100 to shift to the power saving mode. By performing the processes in step S204 and step S209, the MFP 100 is thus controlled not to shift to the power saving mode while performing the processes in step S205 to step S208.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-019437 filed Jan. 29, 2010, which is hereby incorporated by reference herein in its entirety.

1. An information processing apparatus which operates in a first mode or a second mode, the apparatus comprising:
a volatile storage unit;
a first supplying unit configured to supply power to the storage unit if the information processing apparatus is operating in the first mode;
a second supplying unit configured to supply power to the storage unit if the information processing apparatus is operating in the second mode;
a charging unit configured to charge the second supplying unit if the information processing apparatus is operating in the first mode;
a first measurement unit configured to measure an amount of time that the information processing apparatus operates in the first mode after the information processing apparatus shifts to the first mode; and
a control unit configured to control the information processing apparatus not to shift to the second mode until an amount of time measured by the first measurement unit becomes greater than a first predetermined amount of time.

2. The information processing apparatus according to claim 1, further comprising a second measurement unit configured to measure a total amount of time that the information processing apparatus has operated in the first mode after power supply to the information processing apparatus has been turned on,
wherein the control unit performs control so that the information processing apparatus does not shift to the second mode until an amount of time measured by the second measurement unit becomes greater that a second predetermined amount of time.

3. The information processing apparatus according to claim 2, wherein the second predetermined amount of time is longer than the first predetermined amount of time.

4. The information processing apparatus according to claim 1, wherein power consumption of the second mode is lower than power consumption of the first mode.

5. A method for controlling an information processing apparatus which operates in a first mode or a second mode, and includes a volatile storage unit, a first supplying unit configured to supply power to the storage unit if the information processing apparatus is operating in the first mode, and a second supplying unit configured to supply power to the storage unit if the information processing apparatus is operating in the second mode, the method comprising:
charging the second supplying unit if the information processing apparatus is operating in the first mode;
measuring an amount of time that the information processing apparatus operates in the first mode after the information processing apparatus shifts to the first mode; and
controlling the information processing apparatus not to shift to the second mode until the measured amount of time becomes greater than a first predetermined amount of time.
